(19) United States
(12) Patent Application Publication
(10) Pub. No.: US 2025/0375856 A1
(43) Pub. Date: Dec. 11, 2025

(54) Locking Plier Connector

(71) Applicant: Robert Hugh Tavener Darby, Sydney (AU)

(72) Inventor: Robert Hugh Tavener Darby, Sydney (AU)

(21) Appl. No.: 18/736,421

(22) Filed: Jun. 6, 2024

(51) Int. Cl. B25B 5/00; B25B 5/10

(52) U.S. Cl. CPC B25B 5/006; B25B 5/10

(57) ABSTRACT

An apparatus with single part body plus fastener for rigidly connecting locking pliers to commonly available mounts to afford simple, highly versatile and capable work holding solutions. A method for attaching mounts to locking pliers by clamping the handle with an adjustable spike inserted in the hole commonly present on plier handles on one side and a hooked feature on the other. The method discloses the spike best mode orientation to the hook to afford clamping of multiple sizes of locking pliers. Mounting thread angle axes relative to the locking plier handle are disclosed that accommodate both clearance between the mount and locking plier jaw tightening features for jaw adjustment and for aligning the fixed jaw with mount axes, for varying sizes of locking pliers. A best mode angle to align the fixed jaw axis with the mount axis is given to suit all sizes of locking pliers in scope.

### CROSS-REFERENCE TO RELATED APPLICATIONS

Not Applicable

### FEDERALLY SPONSORED RESEARCH AND DEVELOPMENT

Not Applicable

### JOINT RESEARCH AGREEMENT

Not Applicable

### PRIOR ART

### Patent Citations (Locking plier connector)

| Cited | Filing | Publication | | |
|---|---|---|---|---|
| Patent | Date | Date | Applicant | Title |
| U.S. Pat. No. | 10 Feb. | 16 May | Raymond F. | Holding |
| 4,089,513 A | 1977 | 1978 | Mack | clamp means |
| | | | | for locking |
| | | | | pliers |
| U.S. Pat. No. | 17 Oct. | 16 Jun. | Elwin F. | Clamping |
| 5,765,822 A | 1996 | 1998 | Mead | apparatus |
| | | | | for securely |
| | | | | holding |
| | | | | objects |
| U.S. Pat. No. | 9 Jul. | 6 Mar. | Curtis T | Bench mount |
| 3,024,018 A | 1959 | 1962 | Manz | for locking |
| | | | | jaw pliers |
| U.S. Pat. No. | 22 Aug. | 10 Feb. | Philip J. | Holder |
| 3,937,451 A | 1973 | 1976 | DiPaola, | |
| | | | Charles M. | |
| | | | Boye | |
| US2844981 A | 25 Feb. | 29 Jul. | George J | Support |
| | 1955 | 1958 | Steine | means for |
| | | | | toggle- |
| | | | | actuated |
| | | | | wrenches |
| | | | | and the like |

### BACKGROUND OF THE INVENTION

### Technical Problem

There is no general purpose, and commercially available devices for quickly and simply connecting and disconnecting commonly available locking pliers, grippers, clamps and accessories to commonly and commercially available mounts for constructing scalable, extensible, and dexterous work holding solutions.

Existing solutions for connecting to locking pliers do not provide standard attachment features for connecting the pliers to standard mounts and or commonly available mounting solutions.

Existing locking plier clamping solutions afford clamping only via the features they include such as bench clamps and bespoke connection features and they do not provide general purpose mounting options.

Existing locking plier clamping solutions do not afford connection to the wide range of mounts available which limits their utility to basic use cases only.

Existing solutions for connecting to locking pliers do not cater for the full range of locking plier sizes which inhibits the utility of these solutions.

Existing dexterous work holding solutions including helping hands or third hand solutions are limited in reach, rigidity, selection of grippers, fidelity of adjustment and placement, and offer no fine adjustment of clamping force.

There exists no commercially available method for incorporating locking pliers into third hand work holding solutions for the purpose that machines can hold and position locking piers instead of human hands for the benefits this provides.

Griping and supporting work using locking pliers can be hazardous, uncomfortable, boring, strenuous, injury prone and difficult for humans.

Griping locking pliers is hindered by the fact that the material locking pliers are commonly made from is also frequently hardened which makes it difficult to grip this hard and slippery surface.

### SUMMARY OF THE INVENTION

### Definitions

| Term | Description |
|---|---|
| Locking | Also called Vise-Grips or Mole wrench are pliers that afford |
| plier | locking into position using an “over-center” lever action. |

### Solution to Problem

A locking plier connector is proposed that connects and disconnects simply and rigidly to locking pliers and provides common mounting attachment features so locking pliers can be easily held, mounted, fixed, clamped, and or supported in a plethora of work holding solutions.

A solution is provided that affords the creation of work holding systems incorporating one or more locking pliers to providing a general solution to mounting locking pliers into a workholding solution.

The use of a pointed protuberance for insertion into and clamping of a hole feature labelled P in FIG. 12 commonly found on locking pliers affords rigid mounting and prevents slippage without the need for excessive clamping force as can be required to otherwise clamp to locking pliers made of hardened material.

A locking plier connector was invented to combine the versatility and dexterity of dial indicator arms or bending lockable photography arms, and other commercially available mounts with best-in-class grip solutions such as locking pliers resulting in work holding solutions that resolve many shortcomings with existing solutions.

A one size fits all solution for mounting locking pliers of all sizes to standard mounts is provided.

A method for rigid, removable gripping and mounting of locking pliers to standard mounts such that the orientation of the fixed jaw aligns with the axis of mounting is provided.

A method for gripping and mounting locking pliers is fully disclosed that is simple, rigid, removable and achievable with few parts.

A locking plier connector is disclosed that affords a large number of industry standard mounting options.

People can be removed from harm's way by utilising this universal solution to gripping, supporting and mounting locking pliers mechanically.

A locking plier connector affords mating with locking pliers at three or more points for a rigid attachment, the three or more points on the connector can include the two ends of a hooked top jaw and the conical point of a cone point set screw. The connection points on the locking pliers can include two or more points along the handle and one or more points at the fissure, void or hole commonly found on locking plier handles. Clamping occurs due to the external forces exerted inward on the inner captured locking plier handle via the tightening of the set screw. With the locking plier rigidly captured an array of one or more connection interfaces can be provided by the connector be used to mount the locking pliers for work holding.

Further female ¼-20″ UNC thread or threads affords the attachment of camera arm mounts via their standard ¼-20″ UNC male thread for a quick and rigid connection, the resulting system affords highly dexterous and authoritative work clamping and holding.

### Advantageous Effects of Invention

A locking plier connector affords the rigid, dexterous, versatile, high fidelity, precise and repeatable connection of locking pliers to commonly available mounts via standard connection interfaces.

Further, if included a male dovetail mount affords attachment of dial indicator arms via their standard dovetail female jaws for a quick and rigid connection, the resulting system affords highly dexterous, precise, and authoritative work holding.

With this locking plier connector, highly capably work holding solutions can be achieved for little or no further cost often by simply utilizing common items that already exist in a work shop, machine shop, factory, lab, studio, or maker space.

Clamping is achieved between a pin feature and a hook or hook features onto the male body of a plier handle located between the pin and the hook or hooks. One best mode requirement for the pin was found to be a cone pointed set screw.

The resulting work holding systems are scalable in size, load capacity and reach, afford fidelity of work placement and rigidity, afford fidelity of clamping force and they do not suffer from system spring back issues which are commonly found in existing non rigid products. The locking plier connector has been extended with multiple connection points based on standard commonly used interfaces for an extended range or mounting options. The use of camera mount standard threads afford the integration of locking pliers and a staggering array of photographic mounts.

Replacing humans role in holding locking pliers affords humans safety, protection from dirt, grime, contaminants, poisons, provides comfort, low stress, boredom avoidance whilst affording rigid, strong, fatigue free, high quality work holding solutions. The locking plier connector embodiments offered here allow work holding jobs involving locking pliers to be carried out without the need to put humans to be in harm's way, effectively isolating the work from human involvement. This not only protects humans but also protects the work from human work holding short comings which include but are not limited to fatigue, shaking, vibrations, creep, droop, loss of focus, concentration lapses, low strength, short work duration, need for rest or sleep and many others.

Locking plier connectors can be used in conjunction with existing dexterous arm mounting solutions that approximate the dexterity of human arms which make them a direct replacement for humans in most jobs involving static work holding with locking pliers. Locking plier connectors can be used with scalable mounting solutions for increased utility, dexterity, rigidity, and persistence when compared to humans relatively fixed dexterity, size range, strength etc.

Locking plier connectors can be manufactured to have outer faces sized to be standard reference sizes of 1″×1.5″×¾″ and other standard sizes for handy size references whilst working.

Locking plier connectors can be manufactured to conduct electricity for grounding which affords the benefit for the manufacture of electrically sensitive products when used with a ground connection.

Locking plier connectors can be manufactured to conduct electricity affording use in circuit for welding work holding.

Locking plier connectors can be manufactured with pockets for weight savings and to provide hold down clamping attachment points.

Locking plier connectors can be manufactured from materials that allow them to be used in medical operations, food management and other applications which require specialized material properties.

### BRIEF DESCRIPTION OF DRAWINGS

Embodiments of the present invention will now be described with reference to the accompanying drawings wherein:

FIG. 1 is an orthogonal view of an assembled first preferred embodiment of a locking plier connector showing a dovetail connection feature, a mount point, a set screw 3, the opening of another mount point, the opening of an auxiliary's mount point and the locking plier connector body 2

FIG. 2 is a front view of a first preferred embodiment of a locking plier connector installed on a bendable lockable arm mount 1, the view includes a locking plier connector 2, a cone point set screw 3 installed in the locking plier body 2, an additional cone point set screw 4 of differing length to that of 3, a hex key 5, the fixed jaw parts of a set of locking pliers 7, locking plier parts 8 excluding the those of 7, and a locking plier tightening feature 9 which includes a crank handle and eye hole for tightening with a tommy bar and a clearance gap as annotated as 1.D between the crank handle of 9 and the mount 1.

FIG. 3 is a front view of a first preferred embodiment of a locking plier connector body 2 showing the line E representing the connection orientation between the locking plier handle material edge and the locking plier connector hook or hooks, and a line F with angle of offset from E of A degrees, the line F representing an offset plane of connection between the locking plier connector 2 and common mounts, and a centre line C, orthogonal to F indicating an axis along which mount connections can be aligned, and the angle D which exists between the E and C.

FIG. 4 is a front view showing a first preferred embodiment of a locking plier connector 2 installed on the fixed jaw handle of locking pliers 7 and, the connection between the locking pliers 7 and the connector 2 which occurs at one or more points on the handle's material edge or edges between points 20 and 21 and, the clamping and rigid attachment of the locking plier handle which occurs between the contact points between 21 and 20 and the setscrew 3 which contacts 7 at 22 and, the common location of a fissure or hole labelled 22 commonly found in locking pliers which is utilized for rigid clamping by the insertion of the set screw 3 into this feature affording constraint across several axes and, the inserting of a setscrew 3 into this the hole or fissure at 22 along with the orientation of the set screw to the connector 2 hook feature which is an inventive step which surprisingly affords the rigid attachment to a wide range of locking pliers regardless of their brand, size and handle geometry.

FIG. 5 is a section view J-J of a first preferred embodiment of a locking plier connector 2 showing the connection between the hook feature or features of 2 and the edge of the locking plier handle at the material edge or edges.

FIG. 5A is a detail view M of the section J-J of FIG. 5 further showing a detailed view section J-J of a first preferred embodiment of a locking plier connector 2 showing the connection between the hook feature or features of 2 and the material edge of the locking plier handle at K and or Land, the offset between the set screw 3 axis and the locking plier contact points at K and L as indicated by E and D and, the hook mouth opening size indicated by G and, the offset between the setscrew contact point or points with the locking plier handle labelled K and L labelled as F and, the set screw 3 which can have thread protruding from the base of the connector 2 with distance labelled H which affords the connection of gender benders and other threaded features.

FIG. 6.1 is a side view of a first preferred embodiment of a locking plier connector 2, set screw 3, a threaded mount point shown along with engraving marks which signify the thread standard provided and, a hook feature is indicated.

FIG. 6.2 is a front view of a first preferred embodiment of a locking plier connector 2, and a setscrew 3 and engraving marks which can signify product data for customer awareness, and a dovetail feature is shown.

FIG. 6.3 is a rear view of a first preferred embodiment of a locking plier connector 2, a set screw 3, a threaded mount point with engraving marks which can signify the thread standard provided, and an auxiliaries mount point shown along with engraving marks which can signify thread specifications for the mounting feature.

FIG. 6.4 is a front view of a gender bender 6 or thread connector or adapter which is a commonly available accessory and which includes a threaded hole axially aligned with the outer body which can be used to provide a female threaded connection interface and can simultaneously connect to one or more male threaded features.

FIG. 7 is a bottom view of a first preferred embodiment of a locking plier connector 2 with the plier clamping element 3, a set screw 3 in this example, is shown, and optional engraving marks are shown which can signify the specification of threaded features.

FIG. 8 is a front view of a preferred embodiment of a locking plier connector which includes a bendable arm mount 1, a locking plier connector 2, a cone point set screw 3, a set of locking pliers 7, and a locking plier tightening feature 9 which includes a crank handle and or eye hole for tightening with a tommy bar and, a dovetail mount 13 and magnetic base 12.

FIG. 9 is a rear view of a preferred embodiment of a locking plier connector 2 installed on a bendable arm mount 1 via a threaded connector, a cone point set screw 3, a set of locking pliers 7, and a locking plier tightening feature 9 which includes a crank handle and or eye hole for tightening with a tommy bar and a hex key 5 is also illustrated.

FIG. 10 is an orthogonal view of a preferred embodiment of a locking plier connector 2 installed on a bendable arm mount 1 via a threaded connector, a cone point set screw 3, a set of locking pliers 7, and a locking plier tightening feature 9 which includes a crank handle and or eye hole for tightening with a tommy bar, and an example of an auxiliary mount such as small lockable ball jointed arm 10 which is connected to the auxiliar mount point.

FIG. 11 is a front view of a preferred embodiment of a locking plier connector 2 installed on a bendable arm mount 14 via a threaded connector, and a second locking plier connector 2 installed at the other end of the arm 14 and, a cone point set screws 3 and 4, one for each connector 2, two sets of locking pliers 7, each with locking plier tightening features 9 each including a crank handle and or eye hole for tightening with a tommy bar.

FIG. 12 is an orthogonal view and detailed view E of the void, hole or fissure labelled P commonly present in the handle of locking pliers 7.

TAB. 1 is an item list table form listing items and their item numbers for part labelling throughout the drawings provided.

### DETAILED DESCRIPTION OF PREFERRED EMBODIMENTS

### First Embodiment

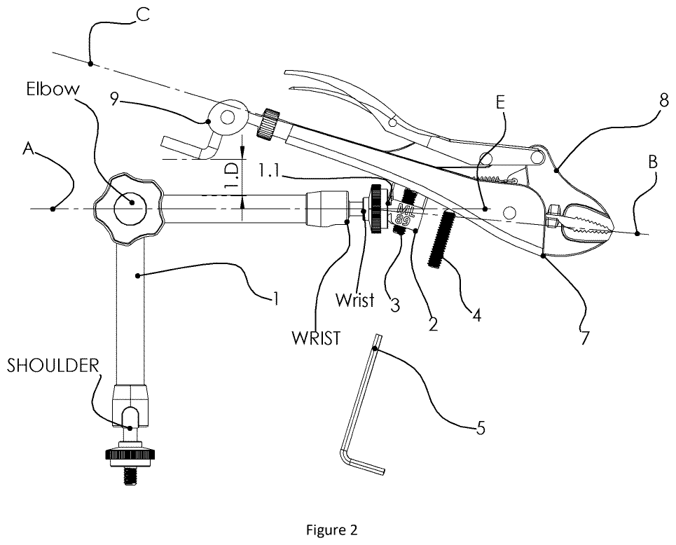

A first embodiment of a locking plier connector 2 of the present invention is illustrated in FIG. 2 as installed on the handle of locking pliers 7 and accompanied by a variation in length of setscrew 4 and a hex key 5.

The locking plier connector 2 can be connected to most locking pliers fixed jaw handles by hooking the hook feature of 2 over the plier handle and by tightening and aligning the set screw until the cone point seats firmly in the fissure or hole commonly located in locking plier handles. Once tight, the connector 2 will be rigidly connected to the locking plier handle 7. In this preferred embodiment a bendable arm is attached to the connector 2 via the female thread provided. With the thread on the bendable arm tightened until it's mounting flange 1.1 is seated firmly onto the connector 2 mount face the locking pliers are oriented such that the plane of the fixed jaw approximately aligns with the axis of the mounting thread. The angle of this mount face is such that alignment of the fixed jaw plane with the mounting thread axis is surprisingly close for all sizes of locking pliers.

In one embodiment a locking plier connector can connect locking pliers sized and with jaw shape suitable for best work holding on to a commonly available ball jointed articulation locking arm mounting system. With the base of this articulated arm fixed to a work station a work piece can be clamped and held rigidly, precisely and oriented with a staggering degree of spatial freedom. And when one or more such work holding systems are combined the result is a general solution to work holding of one or more work pieces oriented with unprecedented freedom in space within the dexterity and reach limits of the bending arms for such work processes which include but are not limited to gluing, welding, soldering, painting, sculpting, tying, animating, machining, measuring etc. Such a general solution for work holding affords an erector set style experience where a great variety of solutions can be constructed with a small set of standard versatile parts, the solution that results is greater than the sum of the parts with which it is constructed.

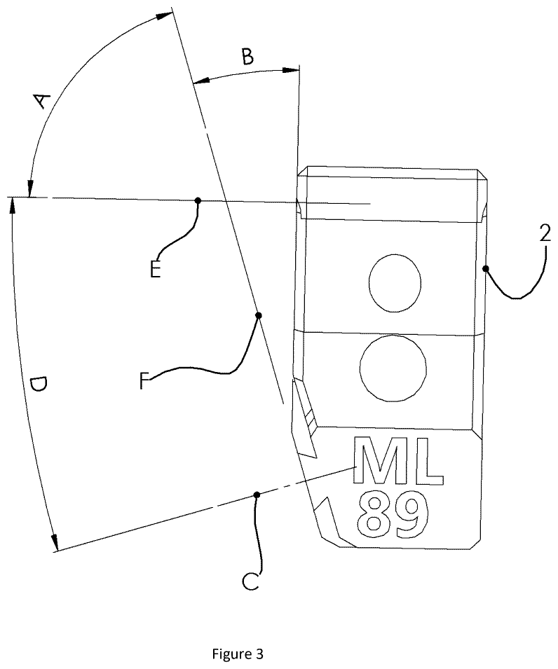

The threaded connector 2 mount face is angled such that a gap thus caused between the arm 1 and the locking pliers tightening part 9 affords clearance which is sufficient to allow locking plier adjustment given the clearance 1.D in FIG. 2 which is created by mount angle D of FIG. 3. A best mode requirement has angle labelled D on FIG. 3 precisely set to or approximately set to 17 degrees.

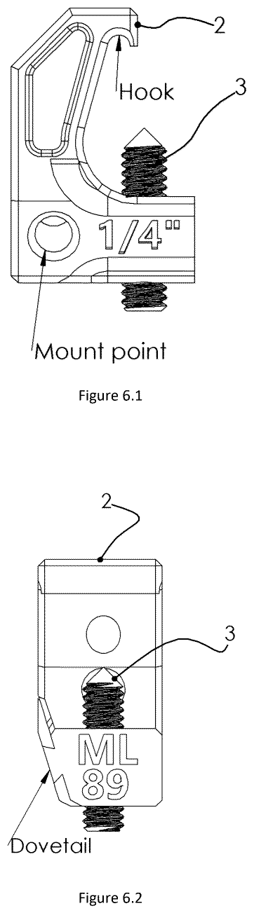

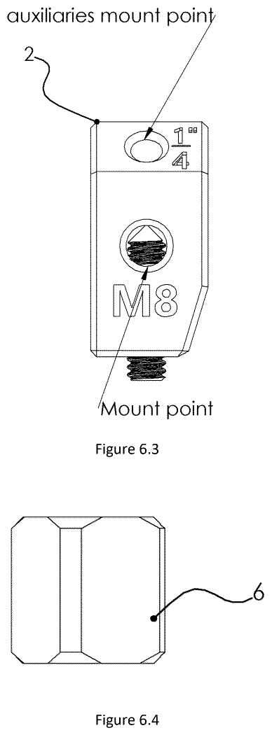

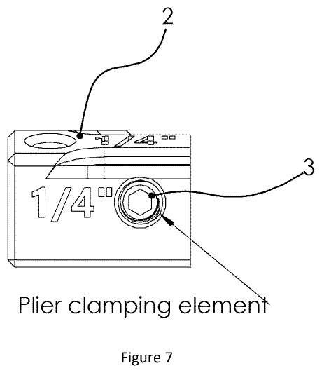

With reference to FIG. 6.1, 6.2, 6.3 and FIG. 7 an embodiment can have ¼-20″ UNC threads for compatibility with commonly available mounts. Further embodiments can include M8×1.25 metric threads and or ⅜-16 UNC threads and or combinations of all these thread specifications or others to suit requirements.

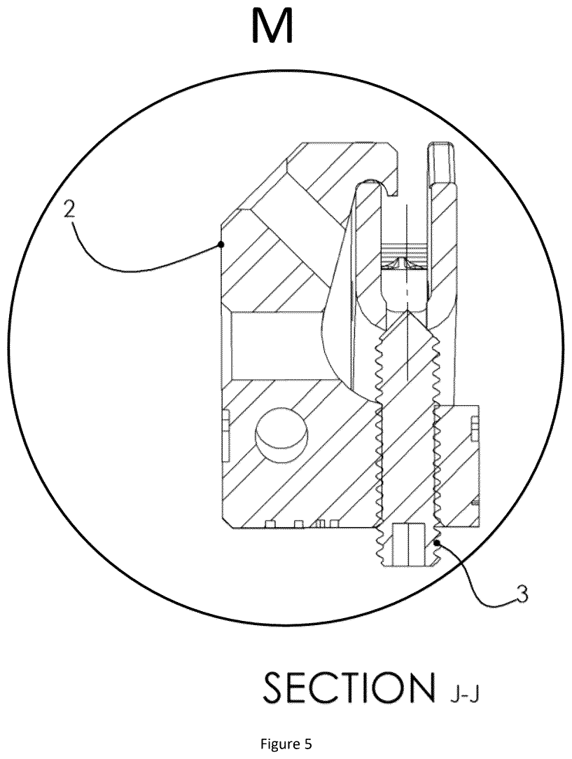

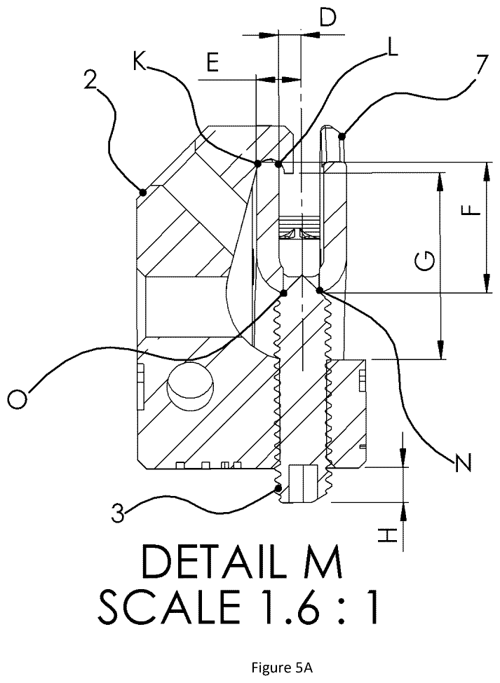

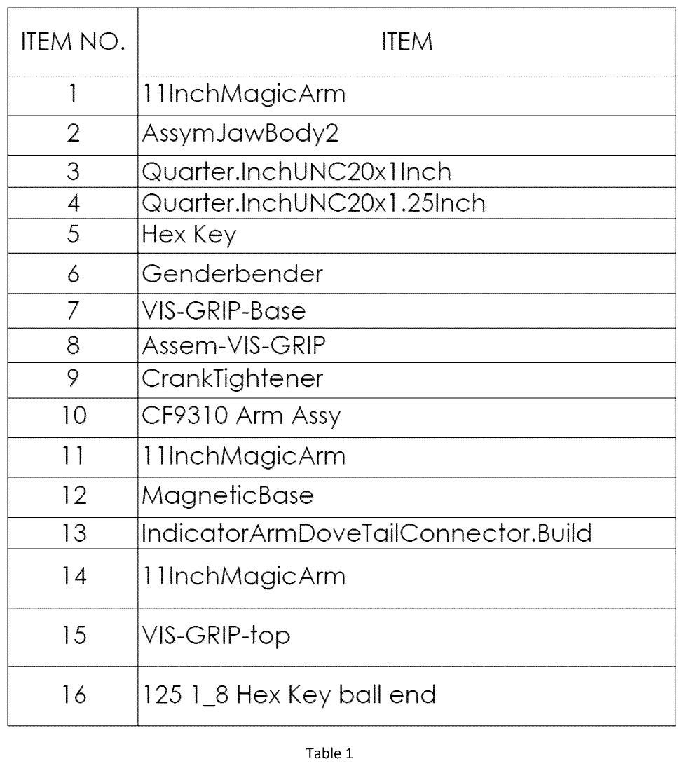

A first embodiment of a locking plier connector 2 of the present invention illustrated in FIG. 5A includes a method for rigidly connecting to and disconnecting from locking plier handles, the method includes clamping of the material edge of locking pier handles via one or more hook features, and
an adjustable clamping feature 3 which includes a screw thread with a protruding end shaped such that it can engage with or be inserted into the fissure or hole labelled P on FIG. 12 commonly present on locking plier handles, and
the orientation of this threaded clamping feature relative to the hook or hooks are such that together they afford rigid attachment to the locking plier handle via the 3 or more points of contact, for example as indicated in FIG. 5A by K, L, N and O.

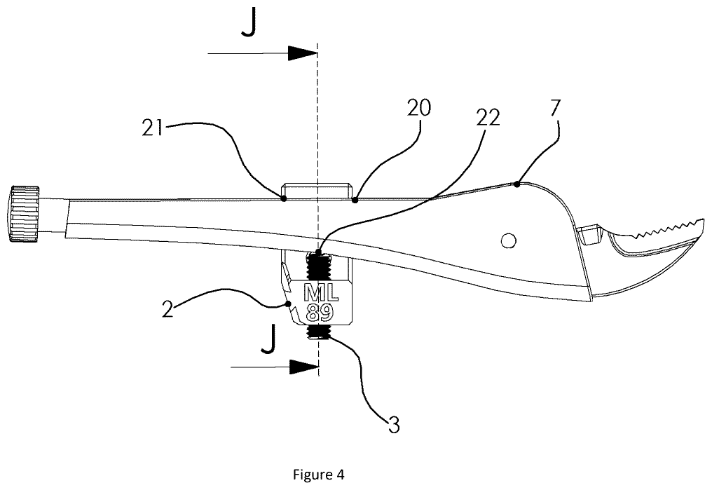

The position and orientation of the clamping feature 3 with respect to the hook or hook features are illustrated in FIGS. 4, 5 and 4A, the offset dimensions between clamping feature 3 axis and the contact points K and L are labelled D and E. The best mode requirements for D and E include D=2.5 mm and E=5 mm however this versatile clamping compatible with multiple locking plier sizes can be achieved with some minor variation in the values of D and E. The hook internal radius and geometry is sized such that the full range of locking pliers can be clamped without interfering with the internal mechanisms or operation of locking pliers. The hook mouth opening geometry labelled G in FIG. 5A can be sized to accommodate a wide range of locking plier handle sizes. The best mode requirement for dimension G is approximately or exactly 21 mm.

A preferred embodiment can include pockets for weight savings, aesthetics, as well as for affording clamping surfaces.

### Second Embodiment

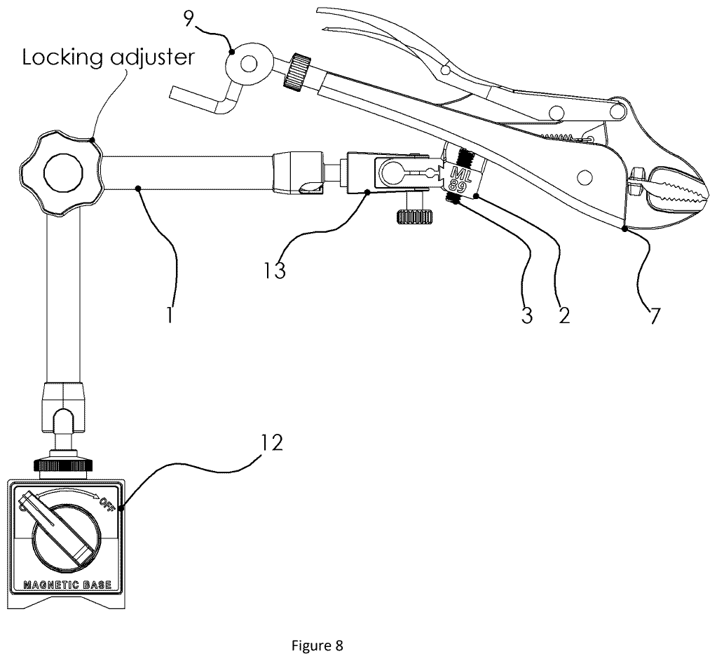

A second embodiment of a locking plier connector 2 of the present invention illustrated in FIG. 8 includes a connector body with a hook feature labelled in FIG. 6.1, and a set screw 3 installed in it for rigidly clamping locking pliers by the handle. The connector body also includes standard connection features which afford connection to commonly available mounts. With the connector body hook feature or features engaged on the material edge of a locking plier handle and with the set screw installed in the connector body and the set screw cone point inserted into the fissure or hole commonly found on the handles of locking pliers, and the set screw is tightened onto the locking plier handle, a rigid connection can be made between commonly available mounts and the locking pliers.

Standard connection features can be oriented such that locking pliers connected to these standard mounts are oriented with the fixed jaw handle angled away from theses standard mount bodies which affords locking plier jaw adjustment via 9 with clearance labelled 1.D in FIG. 2 from the standard mount body for minimal interference especially when locking plier tightening options exist such as but not limited to offset cranks and eye holes for tommy bars 9 illustrated in FIG. 8. The orientation of the standard connection feature relative to the connector body hook also affords the close alignment of the plane of the locking plier fixed jaw and the axis of the associated axis E in FIG. 2 of common mounts. This aids in jaw placement as this jaw plane can be adjusted by rotating the common mount to suit work holding without significant translation of the fixed jaw.

This second embodiment of a locking plier connector 2 can include standard connection features compatible with such connection features as but not limited to dovetail dial indicator arm connection features labelled 13 FIG. 8.

A switchable magnetic base 10 commonly provided on the indicator arm affords rigid connection and disconnection to ferrous and other magnetic bases.

### Third Embodiment

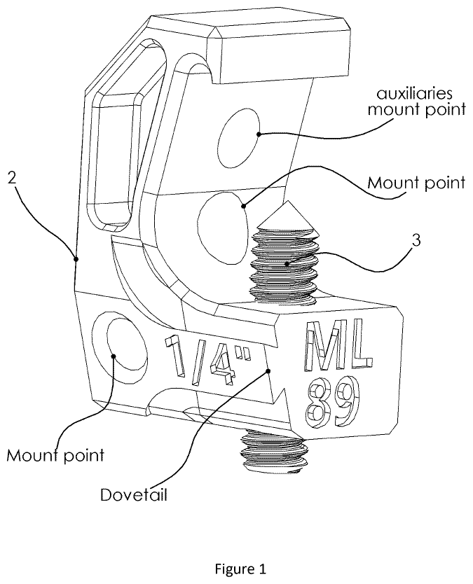

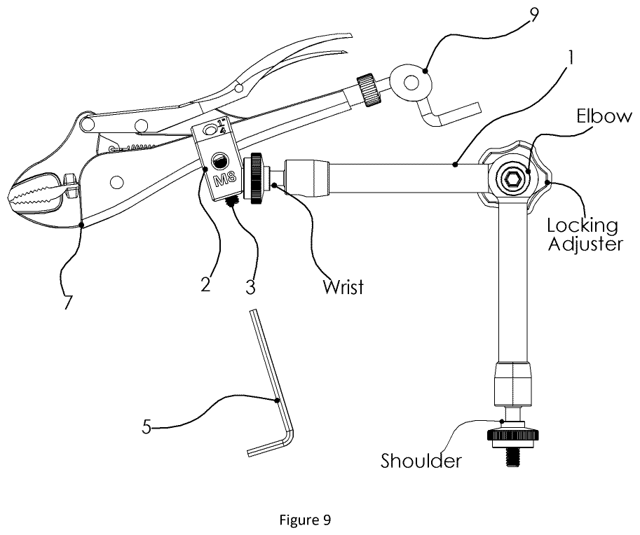

A third embodiment of a locking plier connector 2 of the present invention illustrated in FIG. 9 is as specified in the second embodiment further or alternatively including standard connection features such as but not limited to male or female threaded connection features commonly found on photography and other common mounts, the threaded connection features including but not limited to male or female ¼-20″ UNC threaded features, M8×1.25 mm and other threaded connection features, and or ⅜-16″ UNC threaded connection features and or other thread specifications, some of which require the use of commonly available thread adapters are labelled 1 FIG.1 and labelled, “Mount point” in FIG. 6.1.

A male threaded feature commonly provided at the shoulder end of photography lockable arms 1 affords rigid connection and disconnection of the arm to its surroundings via accessories including but not limited to clamps, weighted bases, magnets, and or directly to female threaded features. The threaded feature on the connector body 2 can be oriented such that locking pliers connected to an arm mount are oriented with the fixed jaw handle angled away from the limb of the arm which affords locking plier jaw adjustment via 9 with clearance 1.D in FIG. 2 from the arm for minimal interference especially when locking plier tightening options exist such as but not limited to offset cranks and eye holes for tommy bars 9 illustrated in FIG. 8. The orientation of the connector body threaded feature relative to the connector body hook features also affords the close alignment of the plane of the locking plier fixed jaw and the axis of the associated arm fastener axis at the wrist seen in FIG. 9. This aids in jaw orientation to the work piece. The attitude or angle of the locking plier fixed jaw relative to the work piece can be adjusted by rotating the pliers about the axis of the arm fastener to suit work holding without significant translation of the fixed jaw. This preferred embodiment affords a staggering degree of freedom for plier orientation and positioning within the reach and dexterity limits of the locking arm selected. This reach and dexterity can be scaled through careful selection of the specifications of dexterous locking arms chosen.

The third embodiment includes a female threaded mounting feature which affords a best mode embodiment which enables a locking plier connector 2 to be screwed onto the male threaded connector at one end of a dexterous locking arm and a second locking plier connector 2 to be connected in the same way at the opposite end of the arm which intern affords the mounting of a pair of locking pliers at each end of the structure. This is a highly versatile utilization of this embodiment especially considering that locking pliers of the same or differing sizes and jaw shapes and structures can be incorporated at each end of this configuration.

### Fourth Embodiment

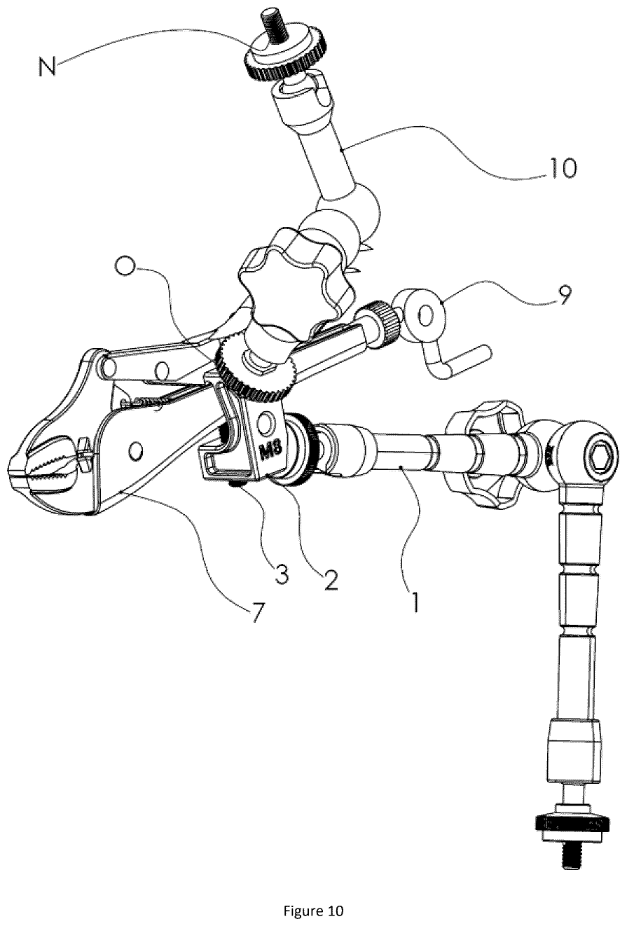

A fourth embodiment as illustrated in FIG. 10 of a locking plier connector 2 of the present invention is as specified as per the second and third embodiments further or alternatively including an auxiliary female threaded mounting feature. This auxiliary female threaded mounting feature is labelled in FIG. 6.3 as “auxiliaries mount point. This auxiliary mounting feature affords the mounting of a large number of commonly available accessories commonly used for photography and other fields including but not limited to locking camera arms 1 as illustrated in FIG. 10, optics, mounts, adapters, hot and cold shoes and their accessories, other locking plier connectors, etc. This auxiliaries mount point affords extended utility of attachment of the locking plier connector with items including but not limited to magnifying glasses, lights, lasers, reflectors, cameras, all for the utility they provide.

### Fifth Embodiment

A fifth embodiment of a locking plier connector 2 of the present invention is illustrated in FIG. 1 which shares features of the second and third embodiments and further includes both a male dovetail connection feature and a female threaded connection feature which are integrated such that the upper face of the dovetail feature is coplanar with the external face of the threaded connection feature. Having these faces coplanar is an inventive step and affords the faces of flanges commonly found on threaded connectors to fasten down flat against this face for a rigid connection whilst also providing the upper face of the dovetail mounting feature for dovetail connection. Both co-exist with interdependent geometric requirements met by this embodiment and both afford the same angle of offset D as shown in FIG. 3 which affords the common alinement of locking plier fixed jaws with the connection axis and also affords clearance for the locking plier adjustment feature 9 shown in FIG. 2 of dimension annotated as 1.D.

### Sixth Embodiment

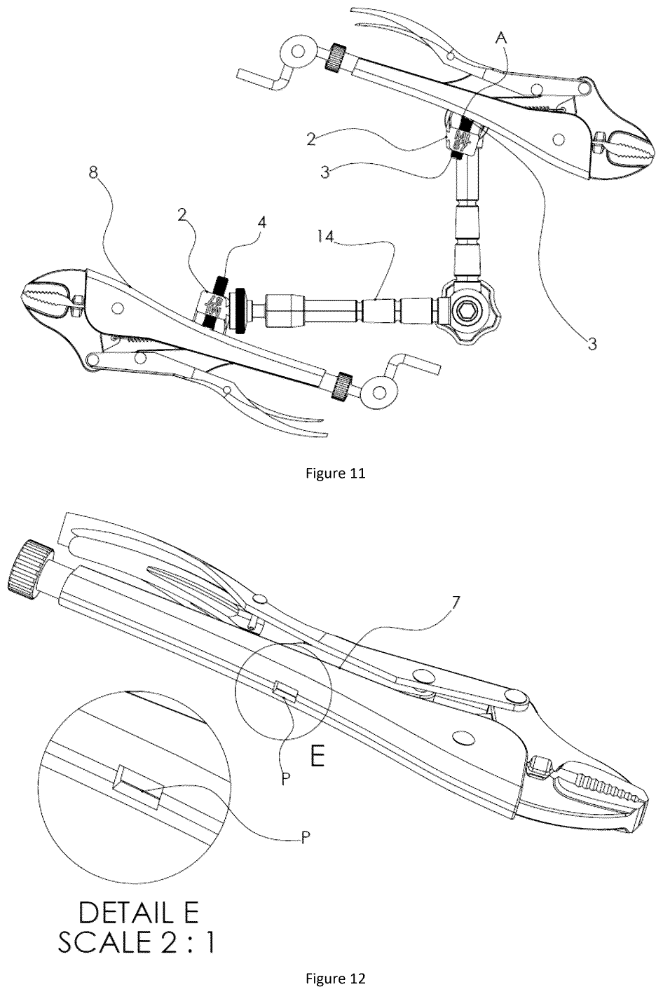

A sixth embodiment of a locking plier connector 2 of the present invention is illustrated in FIG. 11 which can share some or all features of previous embodiments and further includes a female threaded connection mount point labelled Mount point in FIG. 6.3 which has alternate thread specifications and mount point location thus allowing the connection to other mounting options and threaded connectors which include but are not limited to an M8×1.25 female metric thread commonly found on the base of dial indicator arm base connection points. This affords the mounting of dial indicator arms and their dial indicators by means of a locking plier base.

A sixth embodiment of a locking plier connector 2 of the present invention is illustrated in FIG. 11 can also include the possibility of being installed onto an indicator arm male M8×1.25 mm metric threaded connector labelled Mount point in FIG. 6.3; this figure shows a rear view of an embodiment of a locking plier connector 2 to include the location and orientation of an M8×1.25 mm female metric thread selected to match the male thread of commonly available dial indicator locking arms 13 of FIG. 8. This embodiment affords the integration of locking pliers with dial indicator arms in an extensive and varied array of assembly options resulting in a highly capably, precise, rigid and convenient work holding system.

Embodiment six with this mount point affords a best mode embodiment which includes a locking plier connector 2 connected to the base threaded mount on a dial indicator arm and a second locking plier connector 2 connected via the indicator arms dovetail connector which intern affords the mounting of a pair of locking pliers at each end of the structure. This is a highly versatile utilization of this sixth embodiment especially considering that locking pliers of the same or differing sizes can be incorporated at each end of this configuration.

Locking plier connectors 2 can be incorporated multiple times in a system which results in multiple locking pliers for clamping and hence multiple clamping elements being incorporated into a work holding solution, the connectors either joined to each other or joined via interstitial mounting devices such as but not limited to jointed camera arms, gender benders, frames, etc.

### Seventh Embodiment

A seventh embodiment of a locking plier connector 2 of the present invention can be as specified in previous embodiments and manufactured from food grade and or surgical steels that afford use in surgical procedures and food management operations.

### Eighth Embodiment

An eighth embodiment of a locking plier connector 2 of the present invention can be as specified in previous embodiments and manufactured from material that insulate or restrict the conduction of electricity and or heat which may afford use in applications including but not limited to electronics, welding; such materials including but not limited to glass, plastics, ceramics, cellulose-based materials, etc.

### Ninth Embodiment

A ninth embodiment of a locking plier connector 2 of the present invention is illustrated in FIG. 1 comprises a single part body.

### Tenth Embodiment

A tenth embodiment of a locking plier connector 2 of the present invention comprises a body of multiple parts.

### Eleventh Embodiment

An eleventh embodiment of a locking plier connector 2 of the present invention is illustrated in FIG. 1 is constructed with orthogonal outer surfaces set to standardized sizes which affords measurement references of theses standard sizes. Such standard sizes include but are not limited to ½″, 1″, 1.25″, 1.5″ 2″, 10 mm, 15 mm, 18 mm, 20 mm, 25 mm etc.

### INDUSTRIAL APPLICABILITY

The above describes only some embodiments of the present invention and modifications, obvious to those skilled in the art, can be made thereto without departing from the scope of the present invention.

What is claimed is:

1. An apparatus for connecting a wide range of standard locking pliers to wide range of standard, available mounts for unsurpassed performance and versatility in work holding with combined utility greater than the sum of utility from the individual parts, comprising:
a means for attaching to locking pliers that vary greatly in size, shape and brand; and
the means for attaching to wide range of standard, available mounts.

2. The apparatus of claim 1 for connecting a wide range of common locking pliers to wide range of standard, available mounts for unsurpassed performance and versatility in work holding with combined utility greater than the sum of utility from the individual parts, further comprising:
a clamp body including hook geometry that seats on the material edge of locking plier handles of varying scales;
a threaded fastener feature including but not limited to a set screw, a bolt, a cone point set screw, a machine screw, a grub screw, and or other threaded fastener, with end geometry that seats into the hole commonly present on the handle of locking pliers that when adjusted it imparts a clamping force onto the handle at the hole on one side and against the hook feature on the opposing side;
clamp body geometry to orient the threaded fastener relative to the hook feature to accommodate locking pliers of varying scales;
a clamp body fissure or void feature to afford interference free mounting of locking plier handles of varying sizes between the threaded fastener and the hook feature;
clamp body geometry to integrate all clamping features; and
a range of interface features for attaching to a wide range of standard mounts including but not limited to threaded camera mounts, dial indicator dovetail mounts, metric threaded mounts, ¼″-20 UNC threads, ⅜″-16 UNC threads, ⅜″-20 UNF threads, M4,M5, M6, M8 threads of either female or male gender.

3. An apparatus or connector including features to rigidly clamp to locking pliers and mounting features to connect the apparatus to common mounting solutions, the apparatus comprising:
a connector body including one or more hook features sized to capture or seat on the material edge of locking pier handles;
a threaded fastener and a threaded hole in the connector body, the fastener's end to be inserted into the hole or fissure commonly found on locking plier handles;
a threaded hole in the connector body for the threaded fastener to be installed into with axis, orientation, and offset relative to the hook or hooks such that with the hooks engaged with the locking plier handle material edge and with the fastener end inserted into the hole or fissure in the locking plier handle and screwed tight a large range of locking pliers can be rigidly held via the clamping afforded by the tightening of the fastener; and
one or more mounting features to connect the connector to common mounting solutions including but not limited to threaded holes, dovetails, clamping surfaces, welds, and or thread adapters.

4. The locking plier connector of claim 3 where the threaded fasteners include ¼″-20 UNC threads, ⅜″-16 UNC threads and or M8×1.25 metric threads or combinations of these threads or other common threads.

5. The locking plier of claim 3 where the angle D shown in FIG. 3 between the mounting axes and the locking plier handle material edge line is approximately 17 degrees.

6. The locking plier of claim 3 where pockets can be included for weight savings, aesthetics, and or to afford attachment surfaces for clamping.

7. A method for rigid attachment to and disconnecting from locking pliers of widely differing sizes; the method provides attachment via opposing clamping features from opposing sides with the plier handle in the middle; the features on one side comprise a threaded adjustable protuberance feature and on the other side comprise one or more hook features; the protuberance feature is shaped to fit partially into the hole commonly found on the handle of locking pliers and allow rotation, and the hook features are shaped to cup the material edge of locking pliers handles.

8. A single piece clamp body method of attachment and fixed jaw alignment to locking pliers via the clamping method of claim 7 that more specifically captures the square hole of locking plier handles at one side with a threaded spike and hooks onto the material edge of the handle on the other side with geometry such that astonishingly it all works for all pliers great and small.

9. The method for rigidly connecting to locking pliers of claim 8 where the protuberance insertion force is from a threaded feature including but not limited to bolts, set screws, custom fasteners, custom threaded parts, cone point set screws, machine screws, threaded pins, screws, threaded fasteners, threaded rods and or other threaded parts.

10. The apparatus of claim 2 named here as a locking plier connector; the connector further comprising:
a connector body;
one or more elongated hook features sized to capture the material edge of locking pier handles; a threaded hole;
a set screw;
the axis of the threaded hole oriented in angle and offset relative to the hook jaw such that with the jaw located on the locking plier handle and with the setscrew screwed tight into the hole commonly found on locking plier handles, a large range of locking pliers can be rigidly held via the pinched three point clamping afforded by the tightening of the set screw.

11. The locking plier connector of claim 2 further comprising:
features to rigidly clamp to locking pliers; and
mounting features orientated at such an angle that when attached to locking pliers the locking plier jaw clamping can be adjusted easily and without interference from mounts as the locking plier handle is angled away from the axis of the mount.

12. The apparatus of claim 11 for connecting a wide range of standard locking pliers to wide range of standard, available mounts for unsurpassed performance and versatility in work holding with combined utility greater than the sum of utility from the individual parts, further comprising:
a clamp body including hook geometry that seats on the material edge of locking plier handles of varying scales;
a threaded fastener feature including but not limited to a cone point set screw with end geometry that affords seating into the hole commonly present on the handle of locking pliers that when adjusted it impart clamping force onto the handle at the hole on one side and against the hook feature on the opposing side;
clamp body geometry to orient the threaded fastener relative to the hook feature to accommodate locking pliers of varying scales;
a clamp body fissure or void feature to afford interference free mounting of locking plier handles of varying sizes between the threaded fastener and the hook feature;
clamp body geometry to integrate all clamping features;
the angle between the mounting axes and the locking plier handle material edge line is approximately 17 degrees; and
a range of interface features for attaching to a wide range of standard mounts including but not limited to threaded camera mounts, dial indicator dovetail mounts, metric threaded mounts, ¼″-20 UNC threads, ⅜″-16 UNC threads, ⅜″-20 UNF threads, M4,M5, M6, M8 threads of either female or male gender; the setscrew includes a somewhat sharp point which affords insertion into holes or indentation features common to locking plier handles such that the handle is gripped and it's movement relative to the locking plier connector is constrained from translation relative the setscrew in three axes.

13. The apparatus of claim 12 for connecting a wide range of standard locking pliers to wide range of standard, available mounts for unsurpassed performance and versatility in work holding with combined utility greater than the sum of utility from the individual parts, further comprising:
a means for attaching to a locking pliers that vary greatly in size, shape and brand;
the connector is manufactured from materials that afford use in surgical, dental and other sterile procedures including but not limited to stainless steel, surgical steel etc.; and
the means for attaching to wide range of standard, available mounts.

14. The apparatus of claim 1 for connecting a wide range of standard locking pliers to wide range of standard, available mounts for unsurpassed performance and versatility in work holding with combined utility greater than the sum of utility from the individual parts, further comprising:
a means for attaching to a locking pliers that vary greatly in size, shape and brand;
the connector outer faces afford standard or common reference sizes including but not limited to 1″, 1.5″, ¾″, 25 mm, 40 mm, 20 mm etc.; and
the means for attaching to wide range of standard, available mounts.

15. The apparatus of claim 1 for connecting a wide range of standard locking pliers to wide range of standard, available mounts for unsurpassed performance and versatility in work holding with combined utility greater than the sum of utility from the individual parts, further comprising:
a means for attaching to a locking pliers that vary greatly in size, shape and brand;
the material chosen for the connector body is selected to conduct or to inhibit conduction of heat and or electricity; and
the means for attaching to wide range of standard, available mounts.

16. The locking plier connector of claim 1 further comprising:
features to rigidly clamp to locking pliers; and
further comprises mounting features orientated at such an angle that when attached to locking pliers the locking plier jaws can be adjusted easily as the locking plier handle is angled away from the axis of the mount.

17. The Locking plier connectors of claim 1 which furthermore can be used multiple times in a system resulting in multiple locking pliers, and hence multiple clamping elements, being incorporated into a work holding solution; the connectors either joined to each other or joined via interstitial mounting devices such as but not limited to jointed camera arms, gender benders, frames, etc.
